(19) United States
(12) Patent Application Publication
(10) Pub. No.: US 2021/0206091 A1
(43) Pub. Date: Jul. 8, 2021

(54) WIPERS FOR LIGHT TRANSMISSIVE LAYERS

(71) Applicant: HEWLETT-PACKARD DEVELOPMENT COMPANY, L.P., Spring, TX (US)

(72) Inventors: Samantha KANG, Vancouver, WA (US); Alexander David LAWS, Vancouver, WA (US)

(73) Assignee: HEWLETT-PACKARD DEVELOPMENT COMPANY, L.P., Houston, TX (US)

(21) Appl. No.: 16/075,493

(22) PCT Filed: Jun. 27, 2017
(86) PCT No.: PCT/US2017/039542

§ 371 Date: Aug. 3, 2018

(51) Int. Cl. B29C 64/35; B29C 64/314; B29C 64/357; B29C 64/165; B33Y 30/00; B33Y 40/10; B33Y 50/00; B29C 64/386

(52) U.S. Cl. CPC B29C 64/35; B29C 64/314; B29C 64/357; B29C 64/386; B33Y 30/00; B33Y 40/10; B33Y 50/00; B29C 64/165

(57) ABSTRACT

In some examples, an apparatus includes an optical sensor to detect a material in a printing system, a light transmissive layer to pass light to the optical sensor, and a wiper actuatable to wipe a surface of the light transmissive layer to remove particles of the material away from the surface of the light transmissive layer.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 30 model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a block diagram of an arrangement that includes an optical sensor, a light transmissive layer, and a wiper, according to some examples.

FIG. 2 is a block diagram of a three-dimensional (3D) printing system according to some examples.

FIG. 3 is a perspective view of an assembly that includes an optical sensor, a light transmissive layer, and a wiper, according to further examples.

FIG. 4 is a perspective view of a wiper used in the assembly of FIG. 3, according to some examples.

FIGS. 5A and 5B illustrate actuation of a wiper using a moveable sieve, according to additional examples.

FIGS. 6A and 6B illustrate actuation of a wiper according to some examples.

FIG. 7 is a cross-sectional view of an assembly including optical sensor, a light transmissive layer, a wiper, and a fluid flow conduit, according to alternative examples.

FIG. 8 is a block diagram of a printing system according to some examples.

FIG. 9 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the ensuing discussion, use of the terms “above,” “below”, “upper,” and “lower” are to allow for ease of explanation when describing elements in the views shown in various figures. Note that depending on the actual orientation of a device or apparatus, the foregoing terms can refer to other relative arrangements other than being higher or lower along a vertical orientation. Such terms can refer to a diagonal relationship, or to an upside-down relationship (where the terms “above,” “below,” “upper,” and “lower” would be reversed from their ordinary meanings).

In a 3D printing system, a build material can be used to form a 3D object, by depositing the build material as successive layers until the final 3D object is formed. In some examples, a build material can include a powdered build material that is composed of particles in the form of fine powder or granules. The powdered build material can include metal particles, plastic particles, polymer particles, or particles of other materials.

The 3D object can be formed on a build platform of the 3D printing system. Any incidental build material that is not used in forming the 3D object can be passed back to a build material reservoir. To filter out an agglomerated clump of the build material or other objects, the incidental build material can be passed through a sieve to the build material reservoir, which has small openings to allow the particles of the incidental build material to pass through, while blocking larger objects. In some examples, a sieve can be implemented as a mesh frame with the small openings. In other examples, a sieve can have other implementations.

An optical sensor assembly can be used to detect a level of build material at the sieve. If the sieve becomes clogged, then build material can accumulate at the sieve. If the optical sensor assembly detects a level of build material at the sieve that exceeds a threshold level, then that provides an indication of clogging of the sieve such that servicing of the sieve should be performed.

Although reference is made to using an optical sensor assembly to detect a build material layer at a sieve, it is noted that an optical sensor assembly can be used to detect build material levels at other target locations of a 3D printing system, such as in a build material reservoir or another location.

Since an optical sensor assembly in a 3D printing system can be in an environment with airborne build material particles (e.g., powder particles), a light transmissive layer of the optical sensor assembly (through which light passes for detection of a build material at a target location) can become coated with build material particles. The coat of build material particles can interfere with transmission of light though the light transmissive layer, which can reduce the effectiveness of the optical sensor assembly.

In accordance with some implementations of the present disclosure, a cleaning mechanism is provided to remove build material particles away from a light transmissive layer of an optical sensor assembly. The cleaning mechanism includes a wiper that is actuatable to wipe a surface of the light transmissive layer to remove build material particles. In further examples, the cleaning mechanism can also include a fluid flow conduit that passes a flow of fluid (e.g., a gas such as air) that directs build material particles away from the light transmissive layer, to prevent or reduce coating of the light transmissive layer by build material particles. The fluid flow conduit that transports a gas can be referred to as a gas flow conduit.

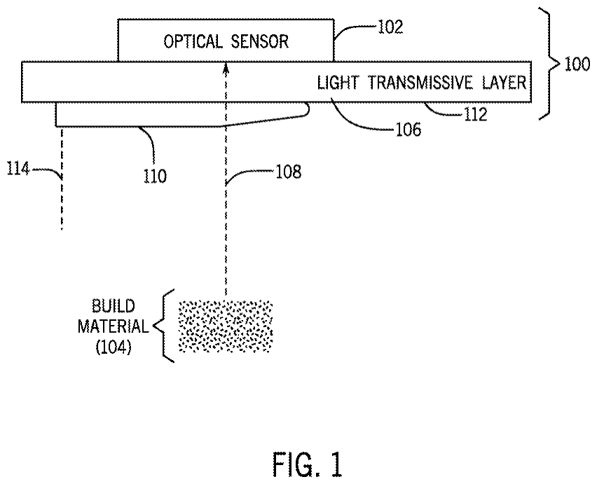

FIG. 1 illustrates an example arrangement that includes an optical sensor assembly 110. The optical sensor assembly 100 includes an optical sensor 102 to detect a build material 104 (or other material) at a target location in a 3D printing system. In some examples, the target location where the build material 104 may be present can be a sieve that is used to filter out clumps of build material or other objects. In other examples, the target location where the build material 104 may be present can be a different part of the 3D printing system.

An optical sensor can refer to a sensor that is able to detect light affected by a target element, such as a build material (or other material) of a 3D printing system. The optical sensor is able to measure light signals to determine a characteristic of the build material, such as an amount or a level of the build material at a target location.

In some examples, the optical sensor 102 is a time-of-flight (ToF) sensor that is able to detect the amount of time for an optical signal that is emitted to travel to the target location, and the amount of time for the reflected light from the target location to reach a light detector at the optical sensor 102. The optical sensor 102 can include a light emitter (or multiple light emitters) and a light detector (or multiple light detectors). For example, a light emitter can include a light emitting diode (LED), and a light detector can include a photodiode. In other examples, other types of light emitters and light detectors can be employed in the optical sensor 102. The light emitter emits a light towards the target location (which can include the build material 104), where the light is reflected from the build material 104 back to the optical sensor 102 for detection by the light detector at the optical sensor 102.

The optical sensor 102 detects the build material 104 through a light transmissive layer 106 that is also part of the optical sensor assembly 100. A light transmissive layer can refer to any layer through which light can pass. In some examples, the light transmissive layer 106 can be formed of a polycarbonate or another type of thermoplastic polymer that is transparent. In other examples, the light transmissive layer 106 can be formed of glass. In further examples, other types of materials that are either transparent or translucent can be employed in the light transmissive layer 106.

In the example of FIG. 1, light reflected from the build material 104 can propagate generally along a light path 108, which passes through the light transmissive layer 106 for detection by the optical sensor 102. Although FIG. 1 shows the light path 108 as generally being vertical in the orientation shown in FIG. 1, it is noted that in other examples, the light path 108 can propagate through the light transmissive layer 106 to the optical sensor 102 at an angle.

The optical sensor assembly 100 further includes a wiper 110 that is engaged (in physical contact) with a lower surface 112 of the light transmissive layer 106. The wiper 110 is moveable with respect to the light transmissive layer 112. Movement of the wiper 110 acts to wipe any build material particles that may have coated the lower surface 112 of the light transmissive layer 106. The wiper 110 can be used to wipe build material particles away from a region where the light path 108 is to pass through the light transmissive layer 106 to or from the optical sensor 102.

In some examples, the wiper 110 can be rotatable with respect to the light transmissive layer 112, such as about rotation axis 114. The rotating action of the wiper 110 serves to wipe any build material particles (or other material particles) away from a lower surface 112 of the light transmissive layer 106.

In other examples, the wiper 110 is translatable across the lower surface 112 of the light transmissive layer 106. The translating movement of the wiper 110 with respect to the light transmissive layer 112 can wipe away any build material particles on the lower surface 112 of the light transmissive layer 106.

In further examples, the optical sensor 102 can detect that the light transmissive layer 106 is coated with build material particles. Such detection can be used to cause actuation of the wiper 110.

Although the present discussion refers to cleaning build material particles from a surface of the light transmissive layer 106, it is noted that in other examples, similar cleaning mechanisms can be applied to clean other types of material particles from a surface of a light transmissive layer.

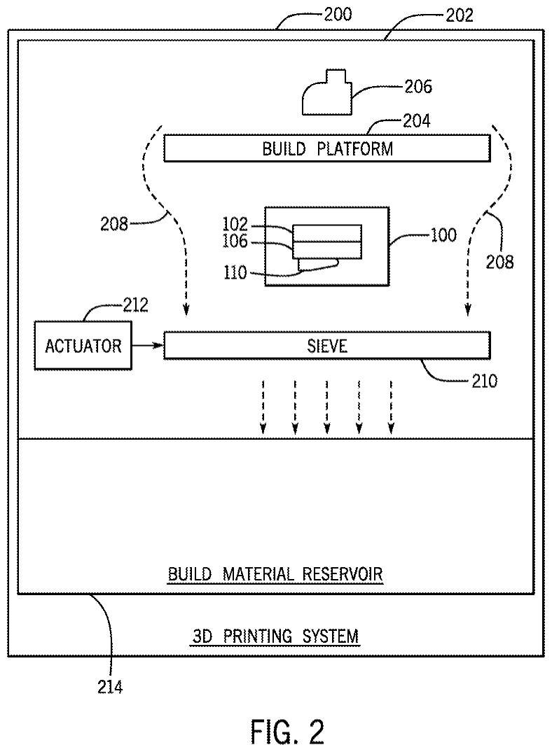

FIG. 2 is a block diagram of an example 3D printing system 200 that includes a build chamber 202. The build chamber 202 can be defined within a build chamber housing inside the 3D printing system 200. The build chamber 202 can be sealed with respect to another part of the 3D printing system, to avoid build material particles from exiting the build chamber 202 and entering other parts of the 3D printing system 200.

A 3D object 206 can be built on the build platform 204. The build platform 204 can be removable from the 3D printing system 200, or the build platform 204 can be fixed in the 3D printing system. Although not shown, a build material dispenser can be provided to dispense a build material onto the build platform 204, to form successive layers of the 3D object 206. Also, printheads or other components for dispensing 3D printing agents can also be used. The 3D printing agents can include ink (or other printing fluid) and/or another type of agent that can be used as part of forming the 3D object 206. For example, an agent can be used to fuse powdered build material, to define edges or shapes of a layer of build material, and/or for other purposes.

As part of the 3D printing process, incidental build material (which is build material that is not used as part of the formation of the 3D object 206) can be directed away from the build platform 204 to a sieve 210, which is used to filter out agglomerated chunks of build material or other larger objects (larger than build material particles). In some examples, an actuator 212 can be used to vibrate the sieve 210 to allow for build material particles to fall through the moving (vibrating) sieve 210 and into a build material reservoir 214 (also referred to as a hopper). The build material reservoir 214 is to collect build material. The build material in the build material reservoir 214 can be used for a subsequent 3D printing process.

In some examples, the actuator 212 can include an electromagnet actuator that can vibrate the sieve 210 using electromagnetic forces. In other examples, other types of actuators can be used. In further examples, the actuator 212 can be omitted.

The optical assembly 100 can be positioned above the sieve 210 to detect an amount of build material (and other materials or objects) in the sieve 210. Clogging of the sieve 210 can cause an overflow condition at the sieve. Thus, as the build material and other objects build up in the sieve 210, the optical sensor assembly 100 can detect this buildup. If the level of the build material and other materials or objects at the sieve 210 exceeds a threshold, then a controller (not shown) in the 3D printing system 200 can take action, such as stop further 3D printing, or to send an alert to a human operator or another target entity (a program or a machine) to issue a warning of the potential clog or overflow condition of the sieve 210.

Since the optical sensor assembly 100 is positioned in a dusty environment filled with build material particles (and potentially other particles), the wiper 110 can be used to keep at least a portion of the light transmissive layer 106 clear of build material particles, so that the optical sensor 102 in the optical sensor assembly 100 can accurately detect the amount of build material and other materials or objects collecting at the sieve 210.

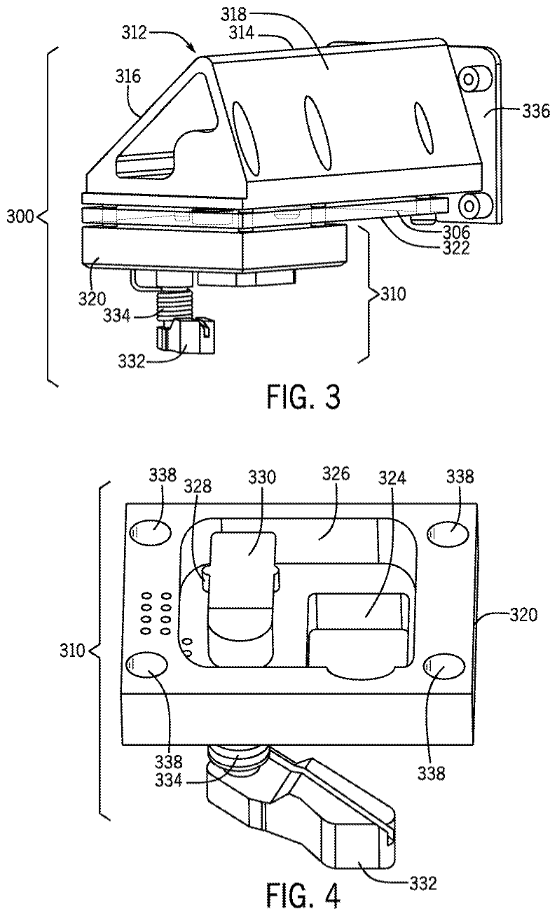

FIG. 3 is a perspective view of an optical sensor assembly 300 that includes a cover 312, an optical sensor (not shown), a light transmissive layer 306, and a wiper 310. The optical sensor is covered by the cover 312. The light transmissive layer 306 is also positioned below the cover 312 in the orientation of FIG. 3. By housing the optical sensor within the cover 312 and placing the light transmissive layer 306 below the cover 312, incidental build material falling from above the optical sensor assembly 300 would not fall onto the optical sensor and the light transmissive layer 306.

In some examples, as shown in FIG. 3, the cover 312 is in the form of a roof that has a ridge 314 and two sloped surfaces 316 and 318 that slope generally away from the ridge 314. The sloped surfaces 316 and 318 allow for incidental build material to fall away from the cover 312.

The wiper 310 has a port structure 320 that is engaged with a lower surface 322 of the light transmissive layer 306. As further shown in FIG. 4, the port structure 320 defines an inner channel 324 through which light can pass through the port structure 320 to and from the optical sensor housed by the cover 312. In examples where the optical sensor includes a light emitter and a light detector as discussed above, light emitted by the light emitter can pass through the inner channel 324 to a target location, such as the sieve 210 shown in FIG. 2. Light reflected from the target location can also pass through the inner channel 324 towards the light detector of the optical sensor.

In addition to the inner channel 324, the port structure 310 further defines a wiper chamber 326 in which a rotatable wiping element 328 is located. The wiper chamber 326 is defined by the walls of the port structure 320. As the wiping element 328 is rotated, the wiping element 328 stays within the wiper chamber 326.

As shown in FIG. 4, receptacles 338 allow for fasteners to extend through the port structure 320 to attach the port structure 320 to the light transmissive layer 306 and the cover 312.

The wiping element 328 has a relatively soft wiping layer 330, which can include a cloth or other soft material. The wiping layer 330 of the wiping element 328 is in physical contact with the lower surface 322 of the light transmissive layer 306. By using a softer material, scratching of the light transmissive layer 306 by the wiping element 328 can be avoided.

The wiping element 328 is operatively connected to an actuator arm 332, which extends below the port structure 320 of the wiper 310. The actuator arm 332 is also rotatable. Rotation of the actuator arm 332 causes corresponding rotation of the wiping element 330.

A biasing element 334, which can be in the form of a spring (e.g., a torsion spring) biases the actuator arm 332 to a rest position. The rest position of the actuator arm 332 corresponds to a rest position of the wiping element 328, as shown in FIG. 4. In the rest position, the wiping element 328 is located away from the inner channel 324 of the port structure 320, such that the wiping element 328 does not cover the inner channel 324 and thus does not interfere with light propagation between the optical sensor and a target location through the inner channel 324.

In the orientation shown in FIG. 4, a counterclockwise rotation of the actuator arm 332 causes a corresponding counterclockwise rotation of the wiping element 328. The counterclockwise rotation of the actuator arm 332 can be caused by a force applied by another component of the 3D printing system 200 (discussed further below). When the force is released from the actuator arm 332, the biasing element 334 causes a clockwise rotation of the wiping element 328 back to its rest position.

As further shown in FIG. 3, the sensor assembly 300 further includes an attachment plate 336, which can be attached to the cover 312. The attachment plate 336 can be used to attach the sensor assembly 300 to a build chamber housing, or other housing of the 3D printing system.

In other examples, instead of a rotatable wiping element 328, a translatable wiping element can be used instead to wipe a surface of the light transmissive layer 306.

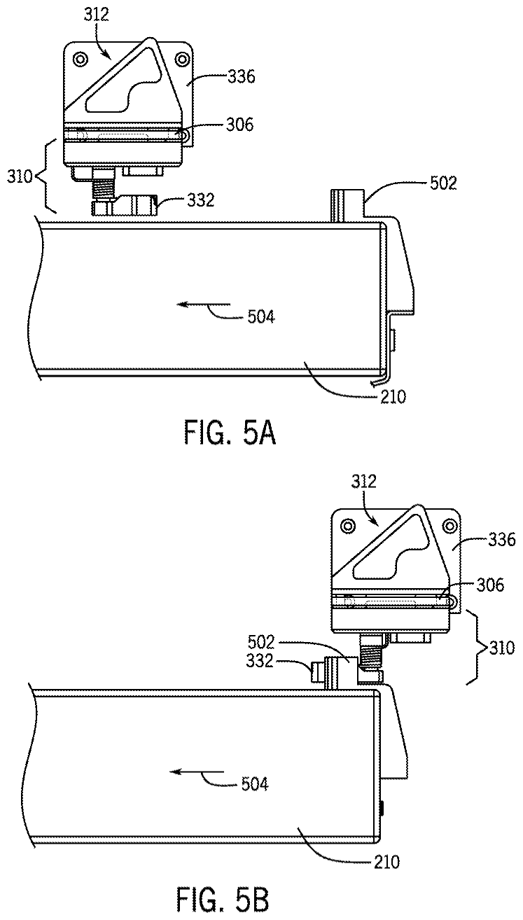

FIGS. 5A and 5B illustrate an example of how the wiper 310 can be actuated using an actuator tab 502 that is mounted on the sieve 210. In some examples, the sieve 210 can be removed from the 3D printing system 200, such as for cleaning. For example, an operator can intermittently remove the sieve 210 from inside the 3D printing system to outside of the 3D printing system, to dump any objects that have been collected by the sieve 210. The sieve 210 can be removed from the 3D printing system by sliding the sieve in a direction indicated by arrow 504 in FIGS. 5A and 5B. As the sieve 210 slides in the direction 504, the actuator tab 502 engages the actuator arm 332 of the wiper 310, to cause rotation of the actuator arm 332 and the corresponding rotation of the wiping element 328 (FIG. 4) to clean the lower surface of the transmissive layer 306.

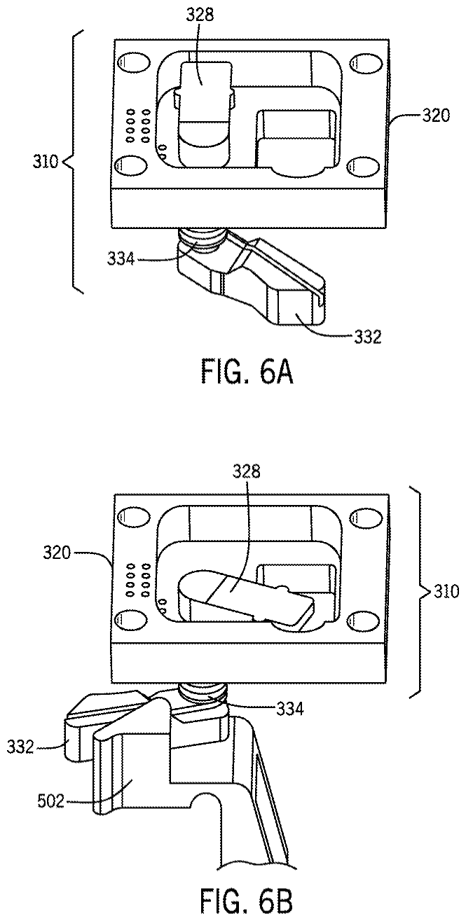

FIGS. 6A and 6B show actuation of the wiper 310 in response to engagement by the actuator tab 502 of the sieve 210. In FIG. 6A, the wiping element 328 and the actuator arm 332 of the wiper 310 are shown in their respective rest positions. FIG. 6B shows actuation of the actuator arm 332 by the actuator tab 502 to cause the actuator arm 332 and the wiping element 328 to rotate in a clockwise direction to a fully rotated position, where the wiping element 328 touches a side wall of the port structure 320. Further movement of the sieve 210 in the direction 504 causes the actuator tab 502 to go past the actuator arm 332, which releases the actuator arm 332 and allows the biasing element 334 to rotate the actuator arm 332 and the wiping element 328 back to their respective rest positions shown in FIG. 6A.

In other examples, instead of using the actuator tab 502 of the sieve 210 or other moveable part to actuate the wiper 310, the wiper 310 can instead be actuated using a motor, vacuum pressure, or other actuation mechanism.

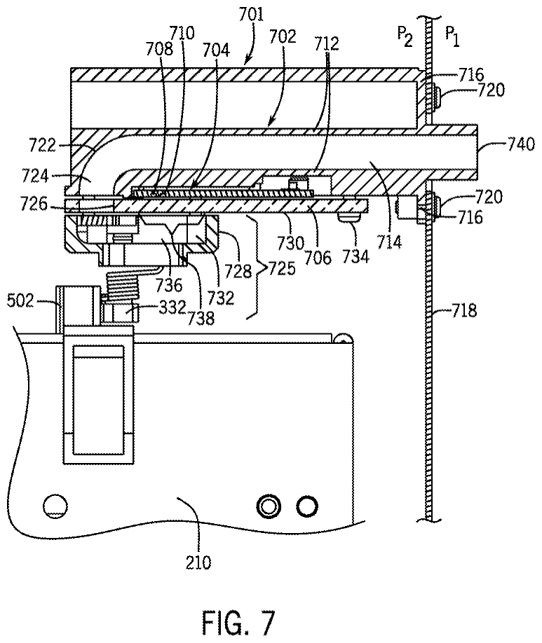

FIG. 7 is a rear view of an assembly according to alternative examples, which depicts a cleaning mechanism that includes both a wiper 725 and a fluid flow conduit 702 that passes a flow of fluid. The assembly includes an optical sensor 704 and a light transmissive layer 706 that is below the optical sensor 704 in the orientation shown in Fig, 7. The optical sensor 704 includes a light emitter 708 and a light detector 710. A cover 701 covers the optical sensor 704 and the light transmissive layer 706.

The fluid flow conduit 702 has an outer housing 712 that defines an inner bore 714 through which fluid (e.g., a gas such as air) can flow. The fluid flow conduit 702 can have a generally tubular shape in some examples. In other examples, the fluid flow conduit 702 can have a different shape. At a first end portion of the fluid flow conduit 702, a flange 716 extends radially outwardly from the housing 712 of the fluid flow conduit 702. The flange 716 can be attached to a build chamber housing 718 by attachment fasteners 720, which can include screws or other types of attachment fasteners.

At a second end portion of the fluid flow conduit 702, the fluid conduit 702 makes a bend (722) such that the inner bore 714 transitions from extending in a generally horizontal direction (in the view shown in FIG. 7) to a generally vertical orientation (in the view shown in FIG. 7). The vertical portion 724 of the inner bore 714 extends through an opening 726 in the light transmissive layer 706.

The wiper 725 that includes a port structure 728 is engaged to a lower surface 730 of the light transmissive layer 706. The port structure 728 can be attached to the outer housing 712 of the fluid flow conduit 702 by attachment fasteners (not shown) extending through holes 732. The attachment fasteners can include screws or other types of attachment fasteners. Note also that the transparent layer 706 can be attached to the outer housing 712 of the fluid flow conduit 702 by an attachment fastener 734.

The port structure 728 has an inner channel 736. A fluid that flows through the inner bore 714 of the fluid flow conduit 702 and through the vertical bore portion 724 can pass to the inner channel 736 of the port structure 728. The inner channel 736 is positioned adjacent the lower surface 730 of the light transmissive layer 706, and the inner channel 736 runs in a direction away from the light transmissive layer 706. The flow of fluid that passes to the inner channel 736 exits from the bottom end of the port structure 728, which effectively directs the flow of fluid away from the lower surface 730 of the light transmissive layer 706.

The inner channel 736 of the port structure 728 effectively defines a sensor window 738, which is a region where light emitted by the light emitter 708 can propagate downwardly to a target location (such as the sieve 210 of FIG. 2), and where light reflected from the target location can pass to the light detector 710.

In some examples, fluid flow in the fluid flow conduit 702 can be induced by a pressure difference on the two sides of the build chamber housing 718. Outside the build chamber housing 718, the pressure is at P₁. Inside the build chamber housing 718, the build chamber is at another pressure P₂, where P₂ is less than P₁, The lower pressure P₂ can be generated by a vacuum source or other pressure generator that can induce a lower pressure within the build chamber inside the build chamber housing 718. Because of the difference in pressure, a flow of fluid can be drawn from outside the build chamber housing 718 through a fluid flow conduit opening 740 and into the inner bore 714 of the fluid flow conduit 702.

In other examples, the flow of fluid in the fluid flow conduit 702 can be caused by a different source, such as by an airflow generator (e.g., a fan) that is located either upstream or downstream of the inner bore 714 of the fluid flow conduit 702.

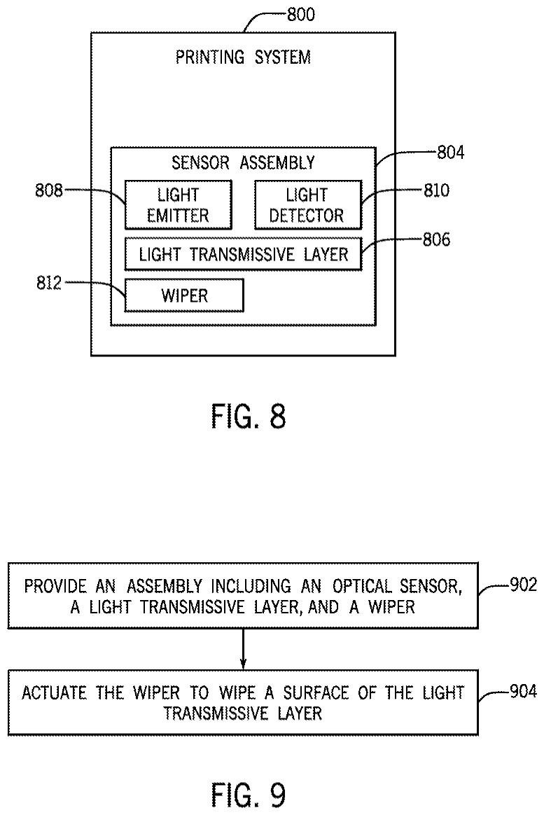

FIG. 8 is a block diagram of a simplified view of a printing system 800 according to some examples. The printing system 800 includes a build platform 802 on which a 3D object is to be formed. The printing system 800 further includes a sensor assembly 804 that has a light transmissive layer 806, a light emitter 808 to direct light through the light transmissive layer to a target location, a light detector 810 to detect light reflected from the target location and passed through the light transmissive layer 806. The sensor assembly 804 further includes a wiper 812 to provide wipe particles of the build material away from the light transmissive layer 806.

FIG. 9 is a flow diagram of a process according to some examples. The process includes providing (at 902) an assembly including an optical sensor to detect a material in a sieve of a printing system, wherein the material is to pass through the sieve, and a light transmissive layer to pass light reflected from the material to the optical sensor. The assembly further includes a wiper.

The process further includes actuating (at 904) the wiper to wipe a surface of the light transmissive layer to remove particles of the material away from the surface of the light transmissive layer.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
an optical sensor to detect a material in a printing system;
a light transmissive layer to pass light to the optical sensor; and
a wiper actuatable to wipe a surface of the light transmissive layer to remove particles of the material away from the surface of the light transmissive layer,

2. The apparatus of claim 1, wherein the wiper is moveable across the surface of the light transmissive layer.

3. The apparatus of claim 2, wherein the surface of the light transmissive layer across which the wiper is moveable is part of a sensor window through which the light reflected from the build material passes.

4. The apparatus of claim 2, wherein the wiper is rotatable from a first position to a second position.

5. The apparatus of claim 1, wherein the optical sensor is to detect the material in a part through which the material is to pass, and wherein the wiper is to be actuated to wipe the surface of the light transmissive layer in response to movement of the part from a first position to a second position.

6. The apparatus of claim 5, wherein the part is removable from the printing system, and wherein the wiper is actuated to wipe the surface of the light transmissive layer in response to movement of the part from the first position inside the printing system to the second position outside the printing system.

7. The apparatus of claim 1, further comprising an actuator arm attached to the wiper, the actuator arm engageable by an actuator tab of a moveable part of the printing system, the actuator arm moveable by the actuator tab of the moveable part to move the wiper across the surface of the light transmissive layer.

8. The apparatus of claim 1, further comprising;
a fluid flow conduit to provide a flow of fluid that directs particles of the material away from the light transmissive layer.

9. The apparatus of claim 8, further comprising:
a port structure defining a sensor window through which the light reflected from the material is to pass to the optical sensor.

10. The apparatus of claim 1, wherein the wiper is actuatable responsive to the optical sensor detecting that the light transmissive layer is coated with the particles of the material.

11. A printing system comprising:
a sensor assembly comprising:
a light transmissive layer;
a light emitter to direct light through the light transmissive layer to a target location;
a light detector to detect light reflected from the target location and passed through the light transmissive layer; and
a wiper actuatable to wipe a surface of the light transmissive layer to remove particles away from the surface of the light transmissive layer.

12. The printing system of claim 11, wherein the sensor assembly further comprises:
a fluid flow conduit to provide a flow of fluid that directs particles away from the light transmissive layer.

13. The printing system of claim 11, further comprising:
a sieve to filter a material, wherein the target location is part of the sieve,
wherein the sensor assembly further comprises an actuator arm attached to the wiper, and the sieve is moveable from a first position to a second position, wherein movement of the sieve from the first position to the second position causes the sieve to engage the actuator arm to move the wiper to wipe the surface of the light transmissive layer.

14. A method comprising;
providing an assembly comprising:
an optical sensor to detect a material in a printing system,
a light transmissive layer to pass light to the optical sensor, and
a wiper; and
actuating the wiper to wipe a surface of the light transmissive layer to remove particles of the material away from the surface of the light transmissive layer.

15. The method of claim 14, further comprising:
moving the sieve from a first position to a second position, wherein moving the sieve from the first position to the second position causes the sieve to engage an actuator arm of the wiper to actuate the wiper.
